(19) United States
(12) Patent Application Publication
(10) Pub. No.: US 2021/0079744 A1
(43) Pub. Date: Mar. 18, 2021

(54) PASSIVE CLAMP ARMS, RELATED SENSING SYSTEMS AND SENSOR ARRAYS, AND METHODS OF OPERATING THE SAME

(71) Applicant: Avalon Sciences Ltd., Somerset (GB)

(72) Inventor: Gary Valentine Tubridy, Somerset (GB)

(21) Appl. No.: 16/569,945

(22) Filed: Sep. 13, 2019

(51) Int. Cl. E21B 23/01; F16B 2/06; G01V 1/52; G01N 27/04; E21B 47/00; E21B 49/00

(52) U.S. Cl. CPC E21B 23/01; F16B 2/06; E21B 49/00; G01N 27/04; E21B 47/00; G01V 1/52

(57) ABSTRACT

A sensing system configured for use in a borehole is provided. The sensing system includes: a body portion; a clamp arm engaged with the body portion, the clamp arm configured to move between (i) a retracted position for lowering the sensing system into the borehole, and (ii) an extended position for locking the body portion in place after being lowered into a position within the borehole; and a dissolvable element for securing the clamp arm in the retracted position until the dissolvable element reacts with an environment in the borehole such that the dissolvable element sufficiently dissolves, thereby allowing the clamp arm to move from the retracted position to the extended position.

### FIELD

The invention relates to the field of sensing systems, and more particularly, to improved systems and methods for clamping of sensing systems in boreholes.

### BACKGROUND

Sensing systems (e.g., including a plurality of sensors) including clamp arms for locking the sensing system in place are utilized in connection with sensing in borehole applications. Such clamp arms are typically actuated using electrically driven motors, or other actuators operated from the surface. Such conventional clamp arms suffer from a number of deficiencies, particularly when electrical power (or other energy provided from the surface) is not available.

Thus, it would be desirable to provide improved sensing systems including clamp arms, and methods of operating the same.

### SUMMARY

According to an exemplary embodiment of the invention, a sensing system configured for use in a borehole is provided. The sensing system includes: a body portion; a clamp arm engaged with the body portion, the clamp arm configured to move between (i) a retracted position for lowering the sensing system into the borehole, and (ii) an extended position for locking the body portion in place after being lowered into a position within the borehole; and a dissolvable element for securing the clamp arm in the retracted position until the dissolvable element reacts with an environment in the borehole such that the dissolvable element sufficiently dissolves, thereby allowing the clamp arm to move from the retracted position to the extended position.

According to another exemplary embodiment of the invention, a sensor array is provided. The sensor array includes (a) at least one sensing system, and (b) a cable for lowering the at least one sensing system into a borehole. The at least one sensing system includes: a body portion; a clamp arm engaged with the body portion, the clamp arm configured to move between (i) a retracted position for lowering the sensing system into the borehole, and (ii) an extended position for locking the body portion in place after being lowered into a position within the borehole; and a dissolvable element for securing the clamp arm in the retracted position until the dissolvable element reacts with an environment in the borehole such that the dissolvable element sufficiently dissolves, thereby allowing the clamp arm to move from the retracted position to the extended position.

According to yet another exemplary embodiment of the invention, a method of operating a sensing system is provided. The method includes the steps of: lowering a sensing system into a borehole, the sensing system including (a) a body portion, (b) a clamp arm engaged with the body portion, the clamp arm configured to move between (i) a retracted position for lowering the sensing system into the borehole, and (ii) an extended position for locking the body portion in place after being lowered into a position within the borehole, and (c) a dissolvable element for securing the clamp arm in the retracted position until the dissolvable element reacts with an environment in the borehole such that the dissolvable element sufficiently dissolves, thereby allowing the clamp arm to move from the retracted position to the extended position; and providing the sensing system in the borehole for a sufficient time such that the dissolvable element sufficiently dissolves, and the clamp arm moves from the retracted position to the extended position.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIGS. 1A-1K are a plurality of views of a sensing system in accordance with an exemplary embodiment of the invention;

FIGS. 2A-2J are a plurality of views of another sensing system in accordance with an exemplary embodiment of the invention;

FIGS. 3A-3G are a plurality of views of yet another sensing system in accordance with an exemplary embodiment of the invention;

FIGS. 4A-4G are a plurality of views of yet another sensing system in accordance with an exemplary embodiment of the invention; and

FIG. 5 is a block diagram view of a sensor array in accordance with an exemplary embodiment of the invention.

### DETAILED DESCRIPTION

In accordance with certain exemplary embodiments of the invention, a clamp arm is held in a retracted position using a dissolvable element (e.g., a metal pin, a metal plug, a metal block, etc.). The chemical composition of the dissolvable element can be adjusted based on, for example, at least one of the borehole fluid composition and temperature. A sensing system (or a plurality of sensing systems) of a sensor array is lowered into a borehole, and after a period of time the dissolvable element will dissolve to actuate the clamp arm (i.e., moving the clamp arm from a retracted position to an extended position), thereby locking the sensing system in a position within the borehole. In accordance with certain embodiments of the invention, after actuation of the clamp arm, the sensing system may still be removed from the borehole even though the clamp arm is in the extended position.

Thus, aspects of the invention facilitate clamping of sensing systems without the need to have either power or communication for operating the clamp arm. That is, stored energy (e.g., spring actuation, hydraulic or pneumatic actuation using borehole liquid) is provided to actuate a clamp arm from a retracted position (the position of the clamp arm during lowering of the sensing system into the borehole) to an extended position (the position of the clamp arm when the sensing system is locked in a position in the borehole). The clamp arm is retained in the retracted position using a dissolvable element. The material of the dissolvable element may be either a composite or metallic material, and can be configured to dissolve after a predetermined time period (a controlled time to dissolve) after contact with (and/or immersion in) the borehole fluid.

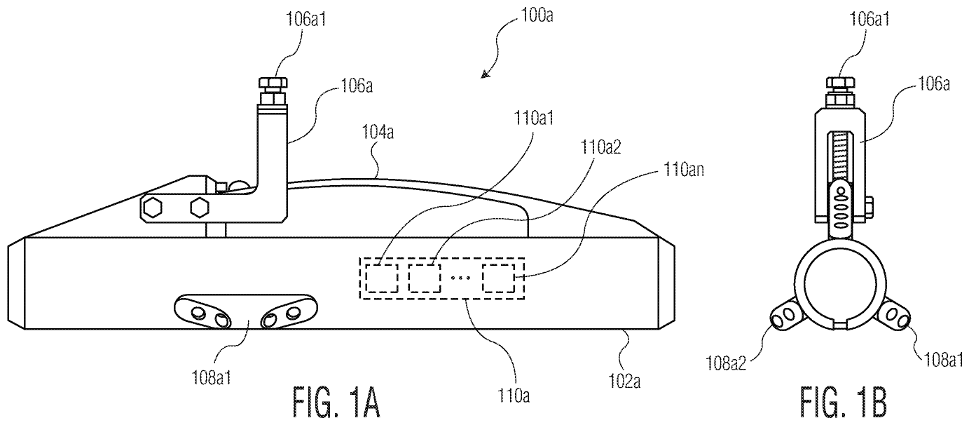

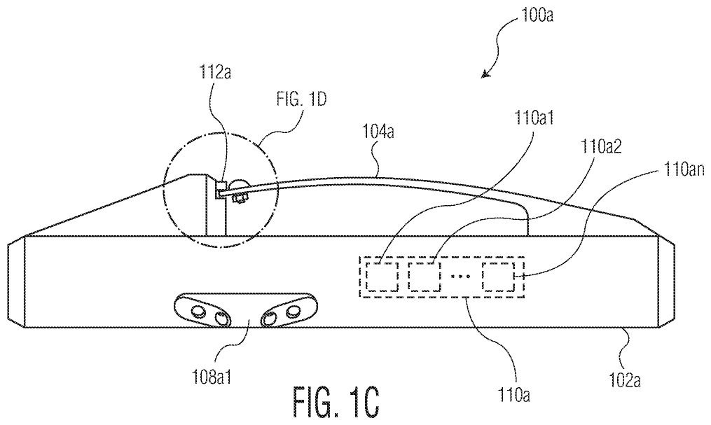

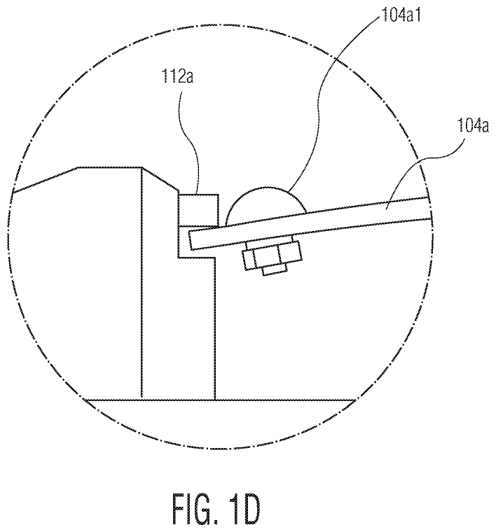

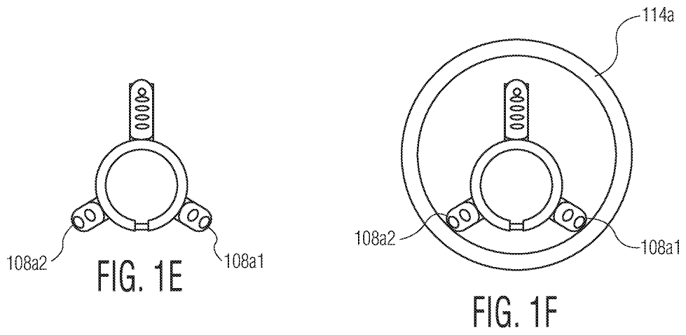

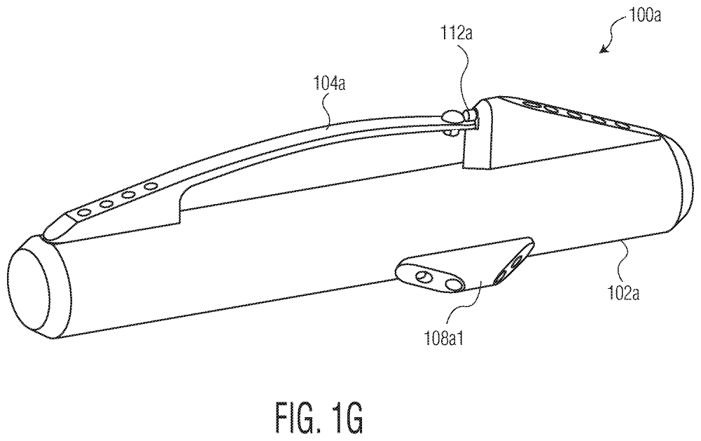

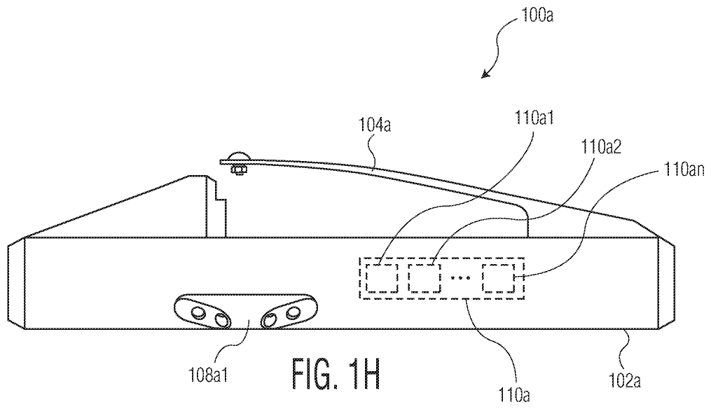

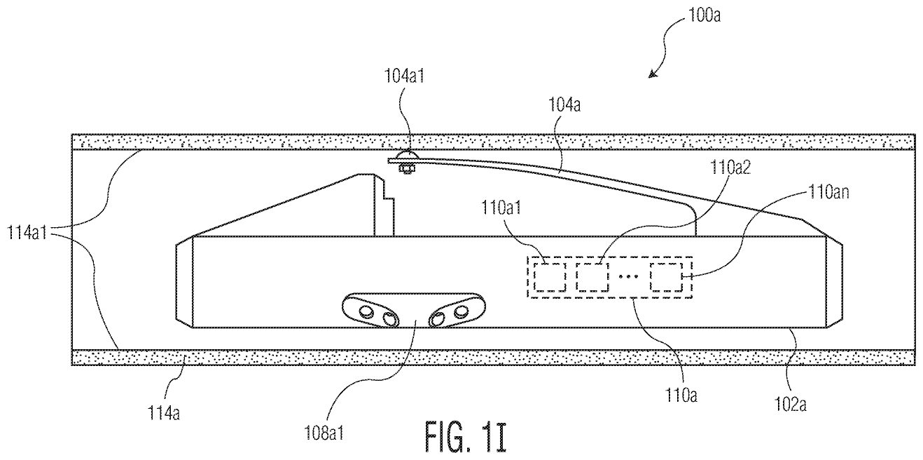

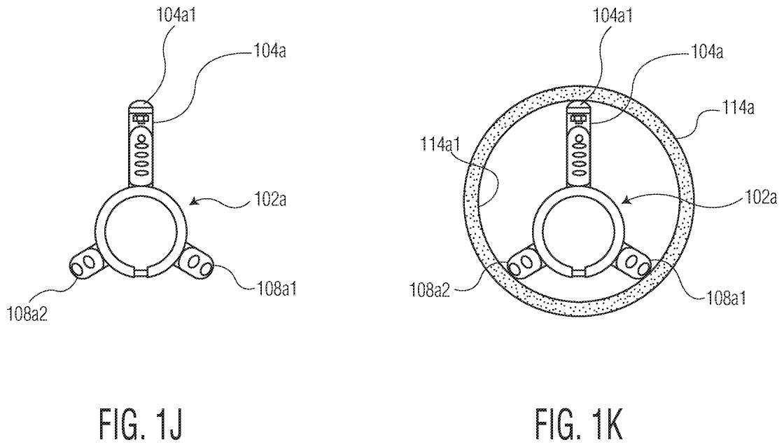

Referring now to the drawings, FIGS. 1A-1K illustrate an exemplary sensing system 100a. FIG. 1A is a side view of sensing system 100a, while FIG. 16 is an end view of sensing system 100a of FIG. 1A as seen from the left end as shown in FIG. 1A. Sensing system 100a includes a body portion 102a and a clamp arm 104a (e.g., a spring based clamp arm) engaged with body portion 102a. Clamp arm 104a is configured to move between (i) a retracted position for lowering sensing system 100a into a borehole, and (ii) an extended position for locking body portion 102a in place after being lowered into a position within the borehole. Sensing system 100a also includes a retaining mechanism 106a (e.g., a lock) (e.g., including a locking bolt 106a1) for securing clamp arm 104a in position (e.g., for use during shipping), where retaining mechanism 106a may be removed from sensing system 100a prior to lowering of sensing system 100a into a borehole. Sensing system 100a also includes legs 108a1, 108a2 outside of body portion 102a, and sensor group 110a (including a plurality of sensors 110a1, 110a2, . . . , 110an) for performing sensing within the borehole. Each sensor in sensor group 110a may include at least one of a particle motion sensor (e.g., at least one of a displacement sensor, a velocity sensor, an accelerometer, a microseismic sensor, a fiber optic accelerometer, among other types of sensors) and a hydrophone, among other types of sensors.

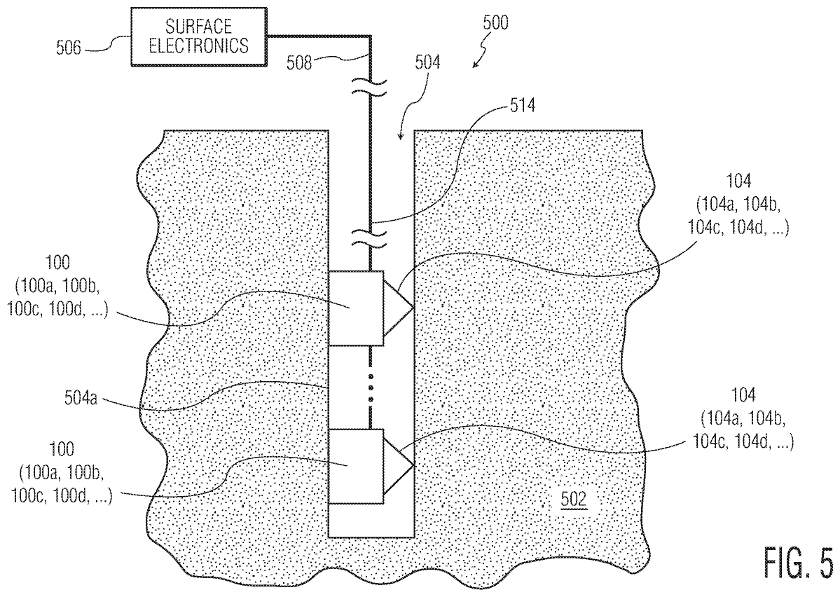

Prior to lowering of sensing system 100a into a borehole (as part of a sensor array, such as shown in FIG. 5), retaining mechanism 106a is removed from sensing system 100a. With retaining mechanism 106a removed, sensing system 100a appears as shown in FIG. 1C. As shown in FIG. 1C, a dissolvable element 112a (shown in detail in FIG. 1D) is provided for securing clamp arm 104a in a retracted position. Various additional views of sensing system 100a with clamp arm 104a in a retracted position are provided in the end view of FIG. 1E, the end view of FIG. 1F (with sensing system 100a in a borehole 114a), and the perspective view of FIG. 1G. Clamp arm 104a is spring actuated to move from the retracted position to an extended position. The extended position is shown in the side view of FIG. 1H, the side view of FIG. 1I with sensing system 100a in borehole 114a, the end view shown in FIG. 1J, and the end view of FIG. 1K (with sensing system 100a in a borehole 114a). In FIGS. 1I and 1K, with clamp arm 104a in the extended position, a contact portion 104a1 of clamp arm 104a is pressed against an inner wall 114a1 of borehole 114a such that sensing system 100a is locked in place (e.g., after being lowered into a desired position within borehole 114a).

Thus, after sensing system 100a is lowered into a borehole (e.g., as part of a sensor array, such as sensor array 500 shown in FIG. 5), dissolvable element 112a reacts with an environment in the borehole (e.g., a liquid in the borehole) such that dissolvable element 112a sufficiently dissolves, thereby allowing clamp arm 104a to move from the retracted position to the extended position.

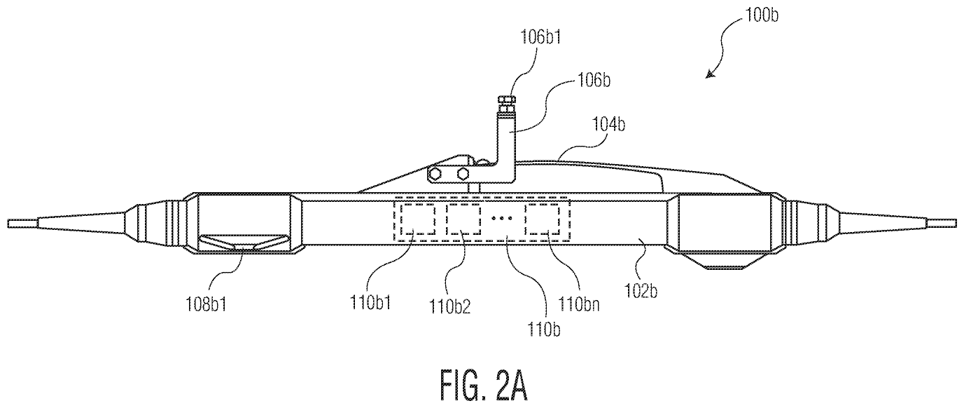

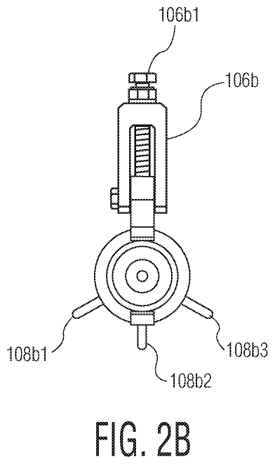

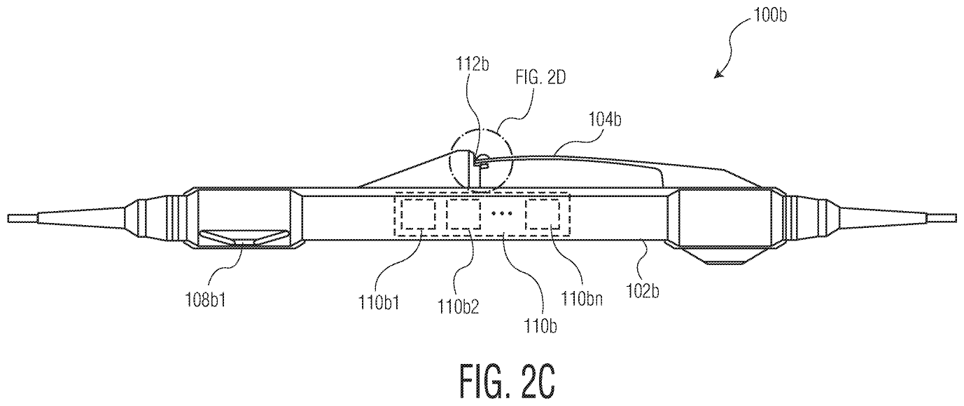

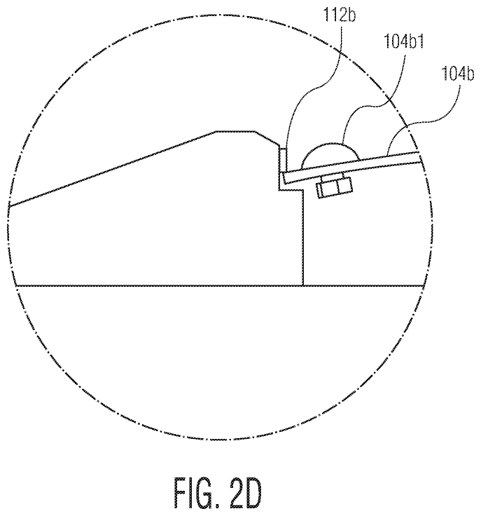

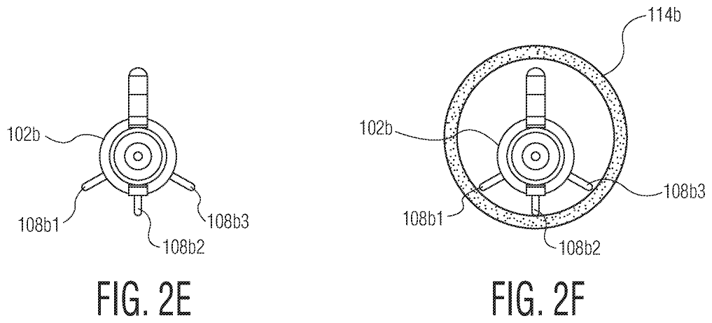

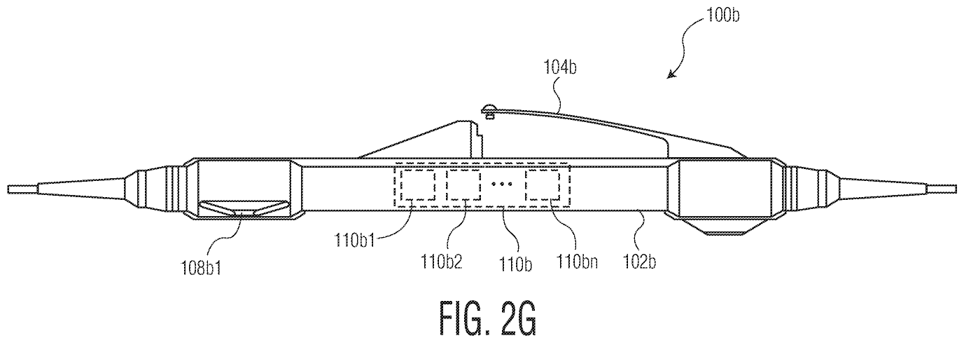

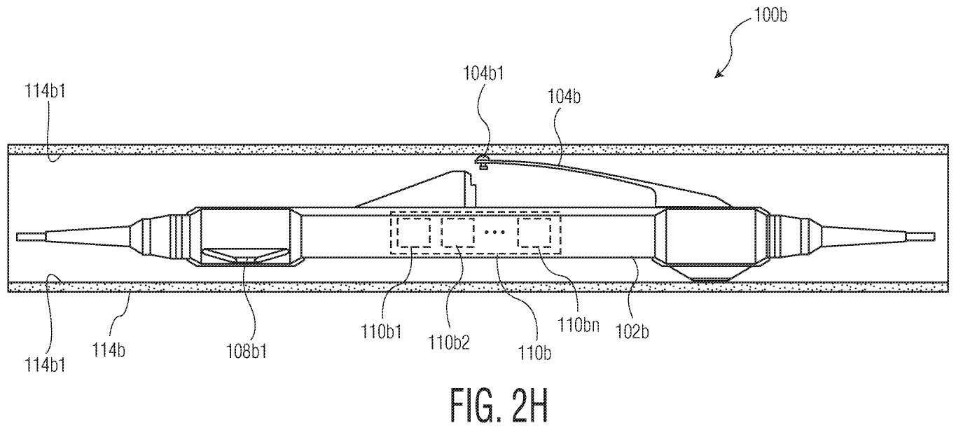

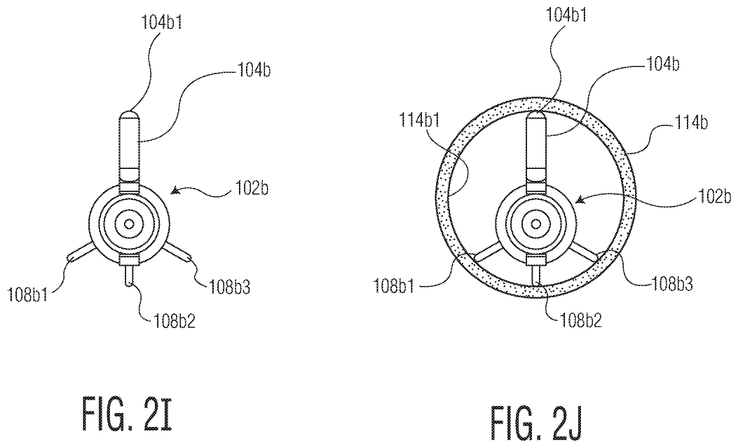

FIGS. 2A-2J illustrate an exemplary sensing system 100b which is similar (with some differences, such as shape of the body portion, and the number of legs, etc.) to sensing system 100a of FIGS. 1A-1K. FIG. 2A is a side view of sensing system 100b, while FIG. 1B is an end view of sensing system 100b of FIG. 2A as seen from the right end as shown in FIG. 2A. Sensing system 100b includes a body portion 102b and a clamp arm 104b (e.g., a spring based clamp arm) engaged with body portion 102b. Clamp arm 104b is configured to move between (I) a retracted position for lowering sensing system 100b into a borehole, and (ii) an extended position for locking body portion 102b in place after being lowered into a position within a borehole. Sensing system 100b also includes a retaining mechanism 106b (e.g., a lock) (e.g., including a locking bolt 106b1) for securing clamp arm 104b in position (e.g., for use during shipping), where retaining mechanism 106b may be removed from sensing system 100b prior to lowering of sensing system 100b into a borehole. Sensing system 100b also includes legs 108b1, 108b2, 108b3 outside of body portion 102b, and sensor group 110b (including a plurality of sensors 110b1, 110b2, . . . , 110bn) for performing sensing within the borehole. Each sensor in sensor group 110b may include at least one of a particle motion sensor (e.g., at least one of a displacement sensor, a velocity sensor, an accelerometer, a microseismic sensor, a fiber optic accelerometer, among other types of sensors) and a hydrophone, among other types of sensors.

Prior to lowering of sensing system 100b into a borehole (as part of a sensor array, such as shown in FIG. 5), retaining mechanism 106b is removed from sensing system 100b. With retaining mechanism 106b removed, sensing system 100b appears as shown in FIG. 2C. As shown in FIG. 2C, a dissolvable element 112b (shown in detail in FIG. 2D) is provided for securing clamp arm 104b in a retracted position. Various additional views of sensing system 100b with clamp arm 104b in a retracted position are provided in the end view of FIG. 2E, and the end view of FIG. 2F with sensing system 100b in a borehole 114b. Clamp arm 104b is spring actuated to move from the retracted position to an extended position. The extended position is shown in the side view of FIG. 2G, the side view of FIG. 2H (with sensing system 100b in borehole 114b), the end view shown in FIG. 2I, and the end view of FIG. 2 (with sensing system 100b in a borehole 114b). In FIGS. 2H and 23, with clamp arm 104b in the extended position, a contact portion 104b1 of clamp arm 104b is pressed against an inner wall 114b1 of borehole 114b such that sensing system 100b is locked in place (e.g., after being lowered into a desired position within borehole 114b).

Thus, after sensing system 100b is lowered into a borehole (e.g., as part of a sensor array, such as sensor array 500 shown in FIG. 5), dissolvable element 112b reacts with an environment in the borehole (e.g., a liquid in the borehole) such that dissolvable element 112b sufficiently dissolves, thereby allowing clamp arm 104b to move from the retracted position to the extended position.

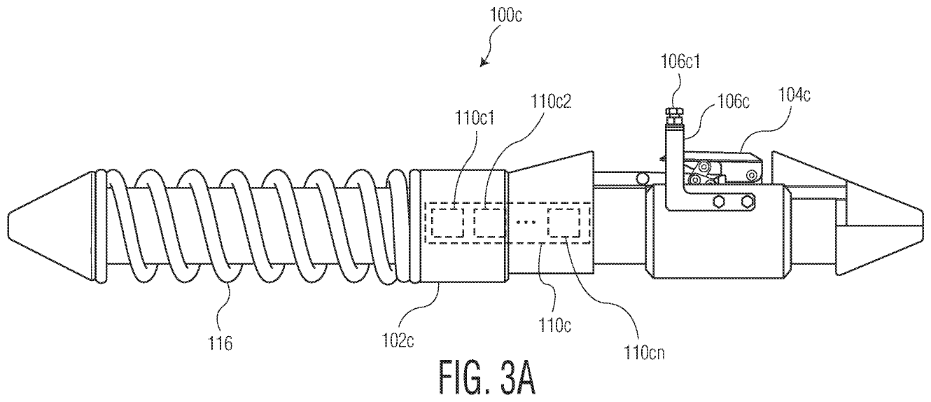

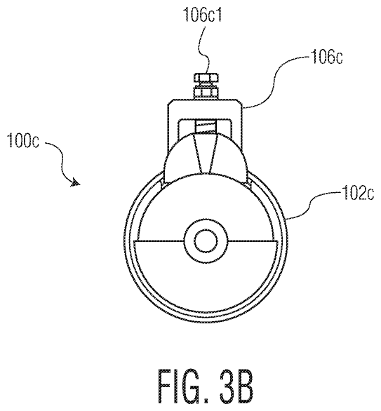

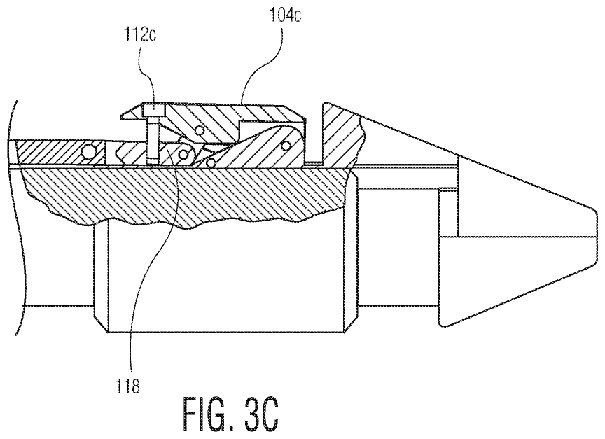

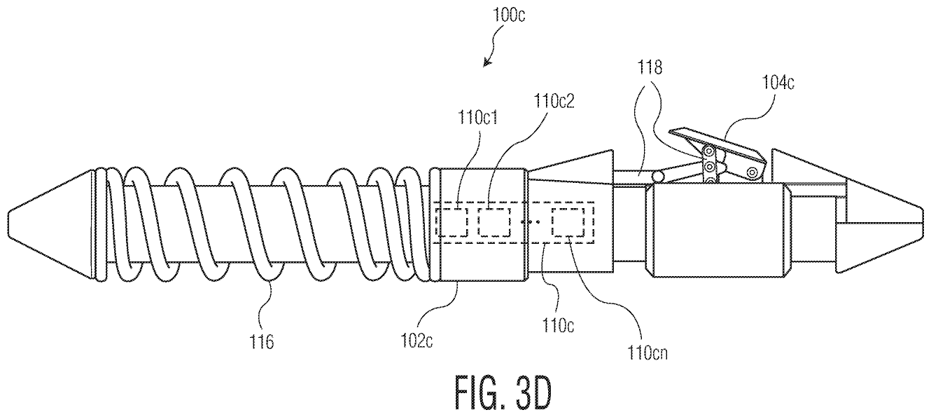

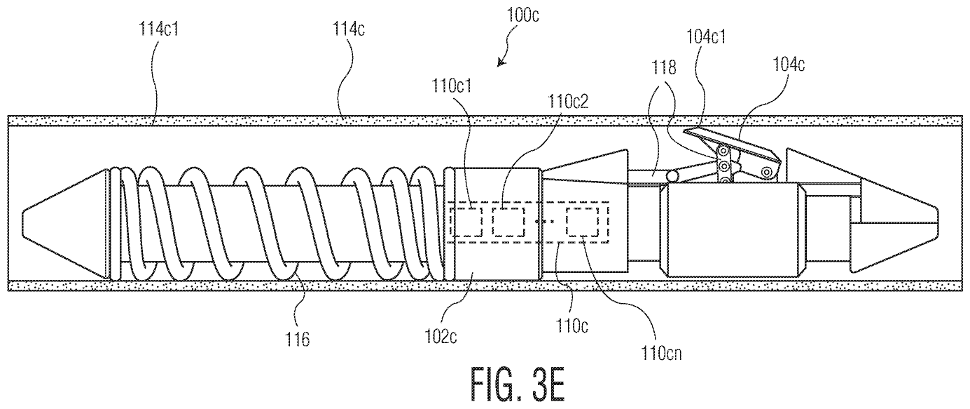

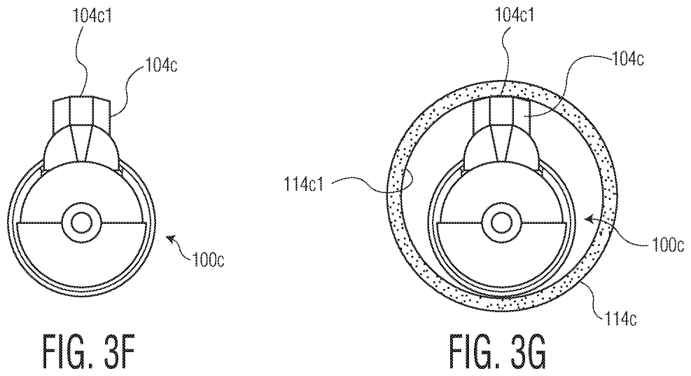

FIGS. 3A-3G illustrate an exemplary sensing system 100c. FIG. 3A is a side view of sensing system 100c, while FIG. 3B is an end view of sensing system 100c of FIG. 3A as seen from the right end as shown in FIG. 3A. Sensing system 100c includes a body portion 102c and a clamp arm 104c (e.g., a clamp arm actuated by a spring 116) engaged with body portion 102c. Clamp arm 104c is configured to move between (i) a retracted position for lowering sensing system 100c into a borehole, and (ii) an extended position for locking body portion 102c in place after being lowered into a position within the borehole. Sensing system 100c also includes a retaining mechanism 106c (e.g., a lock) (e.g., including a locking bolt 106c1) for securing clamp arm 104c in position (e.g., for use during shipping), where retaining mechanism 106c may be removed from sensing system 100c prior to lowering of sensing system 100c into a borehole. Sensing system 100c also includes a sensor group 110c (including a plurality of sensors 110cl, 110c2, . . . , 110cn) for performing sensing within the borehole. Each sensor in sensor group 110c may include at least one of a particle motion sensor (e.g., at least one of a displacement sensor, a velocity sensor, an accelerometer, a microseismic sensor, a fiber optic accelerometer, among other types of sensors) and a hydrophone, among other types of sensors.

Prior to lowering of sensing system 100c into a borehole (as part of a sensor array, such as shown in FIG. 5), retaining mechanism 106c is removed from sensing system 100c. As shown in the partially sectional view of FIG. 3C, a dissolvable element 112c (illustrated as a bolt shaped dissolvable element) is provided for securing clamp arm 104c in a retracted position. After dissolvable element dissolves, spring 116 is configured to extended to the right, pushing linkage 118, where linkage 118 is provided between spring 116 and clamp arm 104c. Therefore, clamp arm 104c is spring actuated to move from the retracted position to an extended position. The extended position is shown in the side view of FIG. 3D, the side view of FIG. 3E with sensing system 100c in borehole 114c, the end view shown in FIG. 3F, and the end view of FIG. 3G (with sensing system 100c in a borehole 114c). In FIGS. 3E and 3G, with clamp arm 104c in the extended position, a contact portion 104c1 of clamp arm 104c is pressed against an inner wall 114c1 of borehole 114c such that sensing system 100c is locked in place (e.g., after being lowered into a desired position within borehole 114c).

Thus, after sensing system 100c is lowered into a borehole (e.g., as part of a sensor array, such as sensor array 500 shown in FIG. 5), dissolvable element 112c reacts with an environment in the borehole (e.g., a liquid in the borehole) such that dissolvable element 112c sufficiently dissolves, thereby allowing clamp arm 104c to move from the retracted position to the extended position.

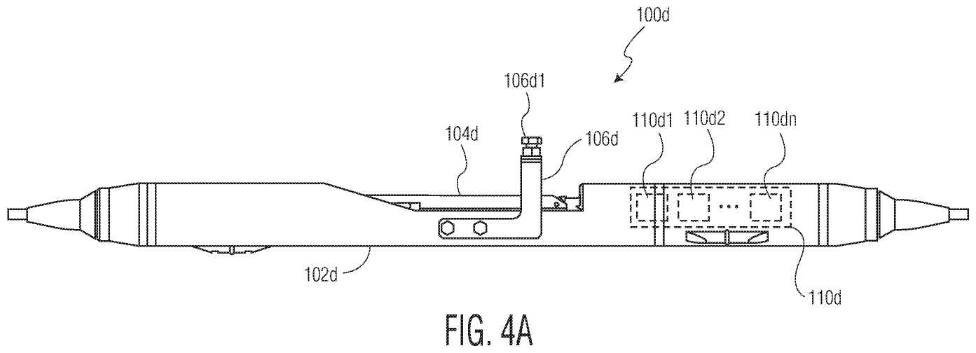

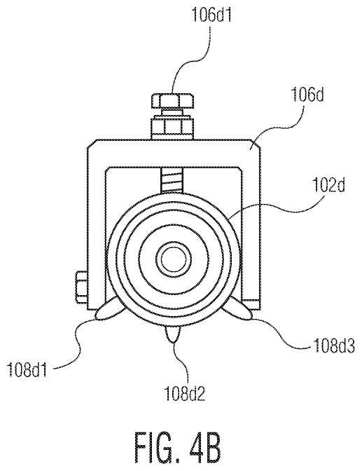

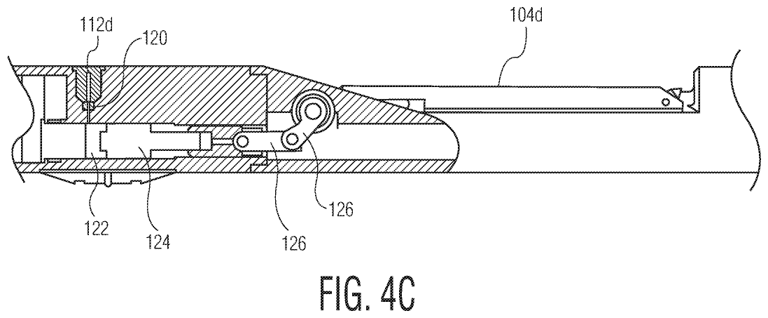

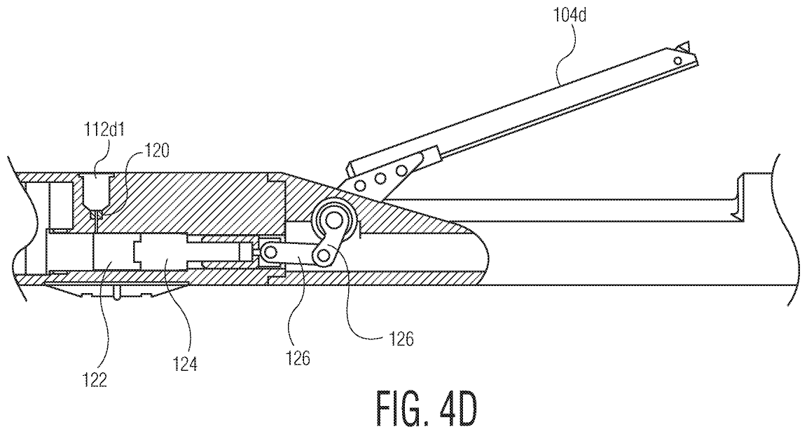

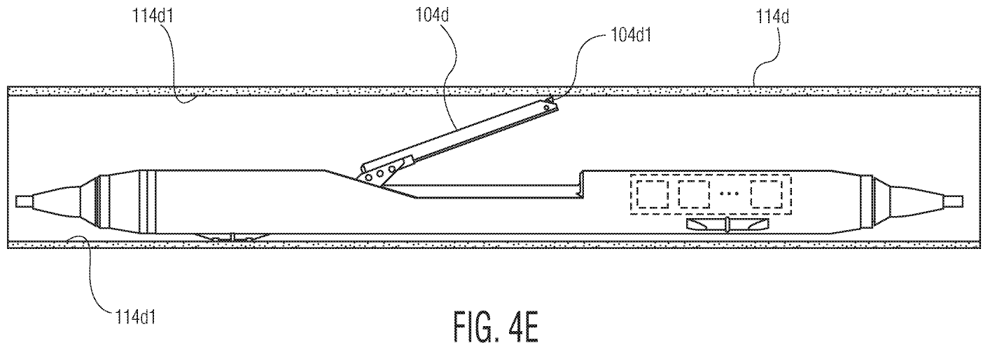

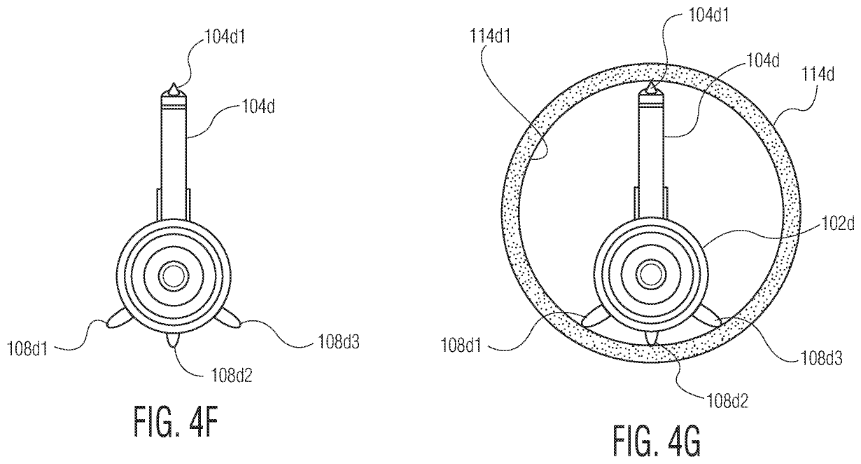

FIGS. 4A-4G illustrate an exemplary sensing system 100d. FIG. 4A is a side view of sensing system 100d, while FIG. 4B is an end view of sensing system 100d of FIG. 4A as seen from the right end as shown in FIG. 4A. Sensing system 100d includes a body portion 102d and a clamp arm 104d engaged with body portion 102d. Clamp arm 104d is configured to move between (i) a retracted position for lowering sensing system 100d into a borehole, and (ii) an extended position for locking body portion 102d in place after being lowered into a position within the borehole. Sensing system 100d also includes a retaining mechanism 106d (e.g., a lock) (e.g., including a locking bolt 106d1) for securing clamp arm 104d in position (e.g., for use during shipping), where retaining mechanism 106d may be removed from sensing system 100d prior to lowering of sensing system 100d into a borehole. Sensing system 100d also includes a sensor group 110d (including a plurality of sensors 110d1, 110d2, . . . , 110dn) for performing sensing within the borehole. Each sensor in sensor group 110d may include at least one of a particle motion sensor (e.g., at least one of a displacement sensor, a velocity sensor, an accelerometer, a microseismic sensor, a fiber optic accelerometer, among other types of sensors) and a hydrophone, among other types of sensors.

Prior to lowering of sensing system 100d into a borehole (as part of a sensor array, such as shown in FIG. 5), retaining mechanism 106d is removed from sensing system 100d. As shown in the partially sectional view of FIG. 4C, a dissolvable element 112d (illustrated as a plug for restricting borehole fluid from entering body portion 102d in area 122 to the left side of piston 124) is provided for securing clamp arm 104d in a retracted position. After dissolvable element dissolves, fluid from the borehole (e.g., water or other fluid in the borehole) enters opening 112d1 (which is now an opening where dissolvable element 112d previously existed, as shown in the partially sectional view of FIG. 4), and travels to area 122. Fluid pressure (caused by the entry of the fluid into area 122) pushes piston 124 and linkage 126, where linkage 126 is provided between piston 124 and clamp arm 104d. Therefore, clamp arm 104d is hydraulically actuated (e.g., actuated using borehole fluid pressure) to move from the retracted position to the extended position. The extended position is shown in the side view of FIG. 4D, the side view of FIG. 4E with sensing system 100d in borehole 114d, the end view shown in FIG. 4F, and the end view of FIG. 4G (with sensing system 100d in a borehole 114d). In FIGS. 4E and 4G, with clamp arm 104d in the extended position, a contact portion 104d1 of clamp arm 104d is pressed against an inner wall 114d1 of borehole 114d such that sensing system 100d is locked in place (e.g., after being lowered into a desired position within borehole 114d).

Thus, after sensing system 100d is lowered into a borehole (e.g., as part of a sensor array, such as sensor array 500 shown in FIG. 5), dissolvable element 112d reacts with an environment in the borehole (e.g., a liquid in the borehole) such that dissolvable element 112d sufficiently dissolves, thereby allowing clamp arm 104d to move from the retracted position to the extended position.

Dissolvable elements within the scope of the invention (e.g., dissolvable element 112a, 112b, 112c, 112d, and any other dissolvable element within the scope of the invention) may be formed from any of a number of different dissolvable materials (e.g., materials that dissolve in a liquid, for example, after a finite amount of time such as less than less than 1 hour, less than 5 hours, less than 10 hours, less than 24 hours, less than 3 days, etc.). For example, the dissolvable element may be formed of a metal material, a metal material including a magnesium additive, a dissolvable alloy material, a composite material, etc. Further, the dissolvable element may take any of a number of shapes (e.g., a block such as elements 104a and 104b, a pin such as element 104c, a plug such as element 104d, among others). A specific example of a dissolvable element is a metal pin which dissolves when immersed in a liquid for a period of time (less than 24 hours). In another specific example, the material of the dissolvable element includes magnesium.

In accordance with certain exemplary embodiments of the invention, the material of the dissolvable element may be determined (e.g., during a design phase) based on a composition of a fluid in the borehole and/or a temperature of a fluid in the borehole.

It should be appreciated that sensing systems within the scope of the invention may, or may not, include “legs”. Sensing systems 100a, 100b, and 100d are illustrated as including legs; however, sensing system 100c does not include legs. Nonetheless, it will be appreciated that a sensing system like sensing system 100c (including a spring surrounding part of the body portion) may include legs. Further, sensing systems including a spring arm (such as sensing systems 100a and 100b), and sensing systems including hydraulic actuation (such as sensing system 100d), may not include legs.

FIG. 5 illustrates a borehole sensor array 500 installed in connection with a borehole 504. That is, a borehole (i.e., a wellbore) 504 is formed in earth 502. Sensor array 500 includes a plurality of sensing systems 100 (e.g., sensing systems 100a illustrated in FIGS. 1A-1K, sensing systems 100b illustrated in FIGS. 2A-2J, sensing systems 100c illustrated in FIGS. 3A-3G, sensing systems 100d illustrated in FIGS. 4A-4G, or any other sensing systems within the scope of the invention). Sensing systems 100 are lowered into borehole 504 to sense information (e.g., vibration information) within borehole 504. In a specific example, borehole 504 may be provided in connection with gas and oil exploration, reservoir monitoring and production monitoring activities, etc. Sensing systems 100 include sensors (e.g., sensors in sensor groups 110a, 110b, 110c, 110d as shown in the drawings) for sensing information related to such activities. Sensing systems 100 are coupled together via interconnect cable(s) 514, and are lowered into borehole 504 via interconnect cable(s) 514. Such sensors may be fiber optic sensors (e.g., fiber optic transducers, fiber optic accelerometers, etc.), electronic sensors, etc.

Each of the sensing systems 100 is desirably securely positioned within borehole 504. For example, each sensing system 100 includes a clamp arm 104 (e.g., such as clamp arms 104a, 104b, 104c, and 104d from FIGS. 1A, 2A, 3A, and 4A) for securely pressing sensing system 100 against a wall (e.g., a casing wall) 504a of borehole 504.

In the example shown in FIG. 5, sensor array 500 also includes surface electronics 506 (e.g., interrogation electronics for interrogating sensors in sensing systems 100), lead cable 508, and interconnect cable(s) 114. According to certain exemplary embodiments of the invention, lead cable 508 and/or interconnect cable(s) 514 carry signals from sensors included in sensing systems 100.

Although the invention has been described with respect to sensors housed within a body portion of a sensing system, it is not limited thereto. Sensors may be provided outside of the body portion of the sensing system, or partially within (and partially outside) of the body portion. Further, sensors included in inventive sensing systems may respond to external stimuli such as pressure, temperature, electrical resistance. Further still, sensors included in inventive sensing systems may operate (sense the desired information) only when the sensing system is pressed against the borehole wall.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A sensing system configured for use in a borehole, the sensing system comprising:
a body portion;
a clamp arm engaged with the body portion, the clamp arm configured to move between (i) a retracted position for lowering the sensing system into the borehole, and (ii) an extended position for locking the body portion in place after being lowered into a position within the borehole; and
a dissolvable element for securing the clamp arm in the retracted position until the dissolvable element reacts with an environment in the borehole such that the dissolvable element sufficiently dissolves, thereby allowing the clamp arm to move from the retracted position to the extended position.

2. The sensing system of claim 1 wherein the clamp arm is spring actuated to move from the retracted position to the extended position.

3. The sensing system of claim 1 wherein the clamp arm uses borehole liquid in connection with hydraulic actuation to move from the retracted position to the extended position.

4. The sensing system of claim 1 wherein the dissolvable element is a metal element.

5. The sensing system of claim 1 wherein the dissolvable element is formed of a composite material.

6. The sensing system of claim 1 wherein the dissolvable element is a metal pin.

7. The sensing system of claim 1 wherein a material of the dissolvable element is adjustable based on a composition of a fluid in the borehole.

8. The sensing system of claim 1 wherein a material of the dissolvable element is adjustable based on a temperature of a fluid in the borehole.

9. The sensing system of claim 1 wherein after the clamp arm is moved to the extended position, the sensing system is locked in position from further lowering into the borehole.

10. The sensing system of claim 1 wherein after the clamp arm is moved to the extended position, the sensing system may be raised out of the borehole with the clamp arm in the extended position.

11. The sensing system of claim 1 further comprising a retaining mechanism for securing the clamp arm in position during shipment, the retaining mechanism being removed from the sensing system prior to lowering of the sensing system into the borehole.

12. The sensing system of claim 1 wherein the clamp arm is moved from the retracted position to the extended position without electrical power or communication.

13. The sensing system of claim 1 further comprising at least one of a particle motion sensor and a hydrophone within the body portion for performing sensing within the borehole.

14. The sensing system of claim 13 wherein the sensing system includes the particle motion sensor, the particle motion sensor including at least one of a displacement sensor, a velocity sensor, and an accelerometer.

15. The sensing system of claim 13 wherein the sensing system includes the particle motion sensor, the particle motion sensor being a microseismic sensor.

16. The sensing system of claim 13 wherein the sensing system includes the particle motion sensor, the particle motion sensor being a fiber optic accelerometer.

17. The sensing system of claim 13 wherein the sensing system includes a sensor which responds to external stimuli such as pressure, temperature, electrical resistance, and wherein the sensor operates when the sensing system is pushed against the borehole wall.

18. A sensor array comprising:
at least one sensing system; and
a cable for lowering the at least one sensing system into a borehole,
the at least one sensing system including (a) a body portion, (b) a clamp arm engaged with the body portion, the clamp arm configured to move between (i) a retracted position for lowering the sensing system into the borehole, and (ii) an extended position for locking the body portion in place after being lowered into a position within the borehole, and (c) a dissolvable element for securing the clamp arm in the retracted position until the dissolvable element reacts with an environment in the borehole such that the dissolvable element sufficiently dissolves, thereby allowing the clamp arm to move from the retracted position to the extended position.

19. A method of operating a sensing system, the method comprising the steps of:
lowering a sensing system into a borehole, the sensing system including (a) a body portion, (b) a clamp arm engaged with the body portion, the clamp arm configured to move between (i) a retracted position for lowering the sensing system into the borehole, and (ii) an extended position for locking the body portion in place after being lowered into a position within the borehole, and (c) a dissolvable element for securing the clamp arm in the retracted position until the dissolvable element reacts with an environment in the borehole such that the dissolvable element sufficiently dissolves, thereby allowing the clamp arm to move from the retracted position to the extended position; and
providing the sensing system in the borehole for a sufficient time such that the dissolvable element sufficiently dissolves, and the clamp arm moves from the retracted position to the extended position.

20. The method of claim 19 wherein the lowering step includes lowering a plurality of the sensing systems into the borehole, the plurality of sensing systems being supported by a cable lowered into the borehole.

21. The method of claim 19 further comprising the step of using at least one of a particle motion sensor and a hydrophone within the body portion for performing sensing within the borehole after the step of lowering.

22. The method of claim 19 further comprising the step of retrieving the sensing system from the borehole with the clamp arm in the extended position.
